(19) United States
(12) Patent Application Publication
(10) Pub. No.: US 2008/0158766 A1
(43) Pub. Date: Jul. 3, 2008

(54) Circuit board and electronic component

(75) Inventor: Takashi Oyama, Niigata (JP)

Correspondence Address: OLIFF & BERRIDGE, PLC, P.O. BOX 320850, ALEXANDRIA, VA, 22320-4850, US

(73) Assignee: FUJI XEROX CO., LTD., TOKYO (JP)

(21) Appl. No.: 11/896,574

(22) Filed: Sep. 4, 2007

(30) Foreign Application Priority Data
Dec. 28, 2006 (JP) 2006-354021

(51) Int. Cl. H05F 3/00

(52) U.S. Cl. 361/220

(57) ABSTRACT

A circuit board, including a static electricity protection conductor formed around a protection target to be protected from static electricity, the static electricity protection conductor having one or more projections and being grounded at one or more points.

### CROSS-REFERENCE TO RELATED APPLICATION

This application is based on and claims priority under 35 USC 119 from Japanese Patent Application No. 2006-354021 filed on Dec. 28, 2006.

### BACKGROUND

1. Technical Field

The present invention relates to a circuit board and an electronic component.

2. Related Art

In the electronic information devices, electronic components have been used in various units.

However, there is concern that those electronic components may be malfunctioned or damaged by even a small amount of static electricity.

Human bodies easily builds up the static electricity by friction of clothes and so on. If this built up static electricity is discharged to the device, this causes the malfunction or damage of the electronic components.

For example, in an operation panel of an image formation device, a switch operated with user's fingertip is provided. When the user operates the switch using his/her fingertip, the static electricity is transferred from the fingertip to the switch and is accumulated, resulting in a high possibility of occurring the malfunction or damage of the switch.

Additionally, an electronic component in the vicinity of the switch operated using the fingertip is in danger of the malfunction or damage from the static electricity transferred from the fingertip.

### SUMMARY

An aspect of the present invention provides a circuit board, including a static electricity protection conductor formed around a protection target to be protected from static electricity, the static electricity protection conductor having one or more projections and being grounded at one or more points.

### BRIEF DESCRIPTION OF THE DRAWINGS

An exemplary embodiment of the present invention will be described in detail based on the following figures, wherein:

FIG. 1 is a diagram showing a circuit board on which a static electricity protection pattern having a projection facing toward a circuit is formed;

FIG. 2 is a diagram showing a circuit board on which a static electricity protection pattern having a projection facing in the opposite direction to the circuit is formed;

FIG. 3 is a diagram showing a circuit board on which a static electricity protection pattern not surrounding a whole circuit is formed;

FIG. 4 is a diagram showing a circuit board on which a static electricity protection pattern having different intervals between projections is formed;

FIG. 5 is a diagram showing a circuit board on which a static electricity protection pattern having different lengths of projections is formed;

FIGS. 6A through 6L are diagrams showing static electricity protection patterns having various shapes of projections;

FIGS. 7A and 7B are diagrams showing static electricity protection patterns having different inclinations of projections;

FIG. 8 is a diagram showing an example of a static electricity protection pattern formed around a periphery of a circuit board;

FIG. 9 is a diagram showing a circuit board on which a static electricity protection pattern for protecting other circuit board is formed;

FIGS. 10A and 10B are diagrams showing a movable circuit board on which a static electricity protection pattern is formed;

FIG. 11 is a diagram showing a circuit board on which a static electricity protection pattern for protecting a whole circuit is formed;

FIG. 12 is a diagram showing a circuit board on which a static electricity protection pattern for protecting an IC is formed;

FIG. 13 is a diagram showing a circuit board on which a static electricity protection pattern for protecting a CCD is formed;

FIG. 14 is a diagram showing a circuit board on which a static electricity protection pattern for protecting a switch is formed;

FIG. 15 is a diagram showing a circuit board on which a static electricity protection pattern for protecting a switch and having a shape not surrounding the switch is formed;

FIG. 16 is a diagram showing a circuit board on which a static electricity protection pattern for protecting a signal line is formed; and

FIGS. 17A and 17B are diagrams showing electronic components having a static electricity protection pattern.

### DETAILED DESCRIPTION

Hereinbelow, a detailed description of an example of a circuit board and an electronic component pertaining to the present invention will be made with reference to attached drawings.

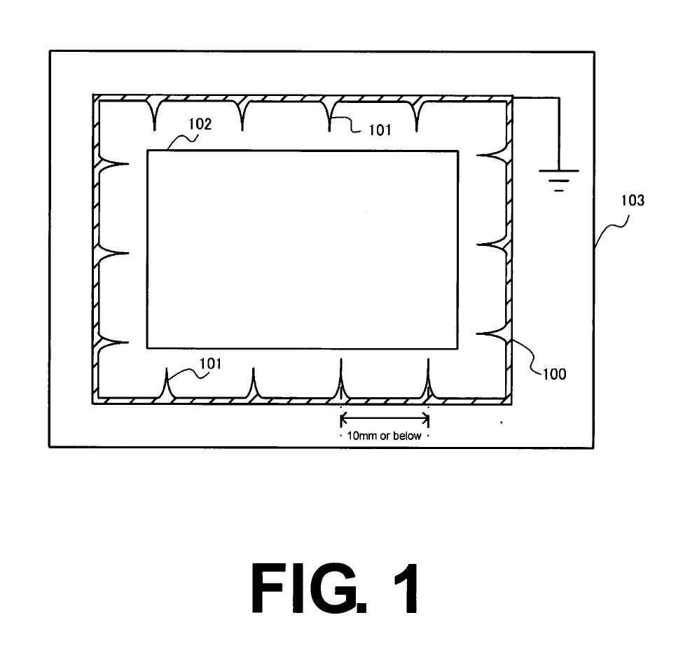

FIG. 1 is a diagram showing a circuit board 103 pertaining to the present invention.

As shown in FIG. 1, the circuit board 103 pertaining to the present invention has a static electricity protection pattern 100 for protecting a circuit 102 on the circuit board 103 from the static electricity.

The static electricity protection pattern 100 is a conductor pattern made of copper foil.

In manufacturing the static electricity protection pattern 100, as similar to other conductor patterns on the circuit board, a pattern is printed with a mask on the positive type photosensitive board, and then the copper located in a printed part is melted through the etching process. Accordingly, the shape of the static electricity protection pattern 100 is formed by the masked part of copper.

The static electricity protection pattern 100 as manufactured in the process described above is connected to the ground, and has a projection 101 with a sharp angled top end.

Additionally, the top end of the projection 101 faces toward the circuit 102 to be protected.

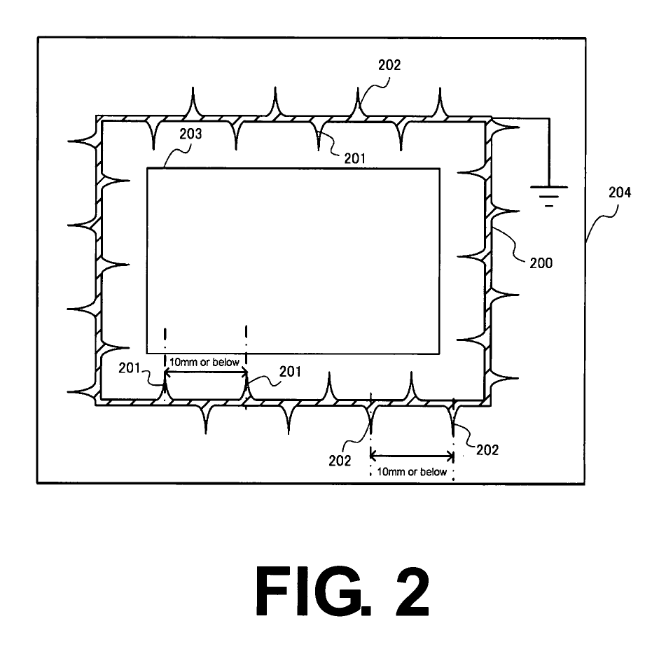

Although a detailed description will be made later with reference to FIG. 2, the direction to which the sharp angled projection 101 faces may not only be the direction toward the circuit 102, but also be an opposite direction against the circuit 102.

Additionally, an interval between each of the adjacent projections 101 in the static electricity protection pattern 100 is set to 10 mm or below.

The interval is measured by the distance between each of the top end of the adjacent projections 101.

Considering that, when the distance is 1 mm, the breakdown voltage of the static electricity is 1 kV, the interval is set to 10 mm or below so as to ensure that the projection always exists within 5 mm from a fingertip when the fingertip of the human having the static electricity of 5 kV touches a device.

Thus, considering the protection from lighter static electricity, the interval between the adjacent projections 101 can be set to less than 10 mm.

Additionally, considering the protection from stronger static electricity, the interval between the adjacent projections 101 can be set to 10 mm or longer.

The circuit board 103 having the static electricity protection pattern 100 is provided to, for example, an operation panel of an image forming device that is operated by a fingertip of the human, a CCD (Charge Coupled Devices) in the fingerprint authentication device with which the fingertip contacts, or a circuit to which a CCD of the digital camera susceptible to the static electricity is installed.

Even if the circuit board 103 is placed to a more likely place where the static electricity occurs, the static electricity protection pattern 100 protects the electronic components susceptible to the static electricity on the circuit board 103 from the static electricity.

For example, when the circuit board 103 is used in the vicinity of the operation panel of the image forming device, the static electricity that is likely to be transferred from the fingertip operating the operation panel to the circuit 102 is guided by the projection 101 of the static electricity protection pattern 100 and is transferred to the ground.

Additionally, the static electricity generated by the operation of the circuit 102 is also guided to the projection 101 and is led to the ground.

Therefore, the circuit 102 to be protected is prevented from accumulating the static electricity, and the device can be protected from malfunction.

Although a detailed description will be made later, the static electricity protection pattern 100 may protect not only the circuit 102, but also various electronic components or signal lines installed on the circuit board 103. In such case, the static electricity protection pattern 100 is formed to surround the periphery of the various electronic components or signal lines to be protected.

Next, with reference to FIG. 2, a description will be made of a case where the sharp angled projection of the static electricity protection pattern formed on the circuit board pertaining to the present invention faces not only toward the protection target, but also in a different direction from the protection target, for example, in the opposite direction to the protection target.

FIG. 2 is a diagram showing a circuit board 204 in a case where the projection of the static electricity protection pattern faces toward the circuit to be protected and in the opposite direction with respect to the circuit to be protected.

As shown in FIG. 2, a static electricity protection pattern 200 formed on the circuit board 204 pertaining to the present invention has a projection 201 facing toward the circuit 203, which is the protection target, to be protected from the static electricity, and a projection 202 facing in the opposite direction to the circuit 203.

As described above, the static electricity protection pattern 200 formed on the circuit board 204 pertaining to the present invention can have not only the projection facing toward the protection target, but also the projection facing in the different direction from the protection target.

Regarding the interval between each of the adjacent projections in this case, the interval between the projection 201 facing toward the circuit 203 and the projection 202 facing in the opposite direction to the circuit 203 is not 10 mm or below, but the interval between the projection 201 facing toward the circuit 203 and the adjacent projection 201 facing toward the circuit 203 is 10 mm or below, while the interval between the projection 202 facing in the opposite direction to the circuit 203 and the adjacent projection 202 facing in the opposite direction to the circuit 203 is 10 mm or below.

Since the protection pattern has the projection facing in the opposite direction to the circuit to be protected, the static electricity transferred from the outside of the circuit board 204 is guided to the projection facing in the different direction, and is led to the ground. Thus, the circuit to be protected is prevented from accumulating the static electricity.

Although a detailed description will be made later, the static electricity protection pattern 200 may protect not only the circuit 203, but also various electronic components or signal lines installed on the circuit board 204. In this case, the static electricity protection pattern is formed to surround the various electronic components or signal lines to be protected.

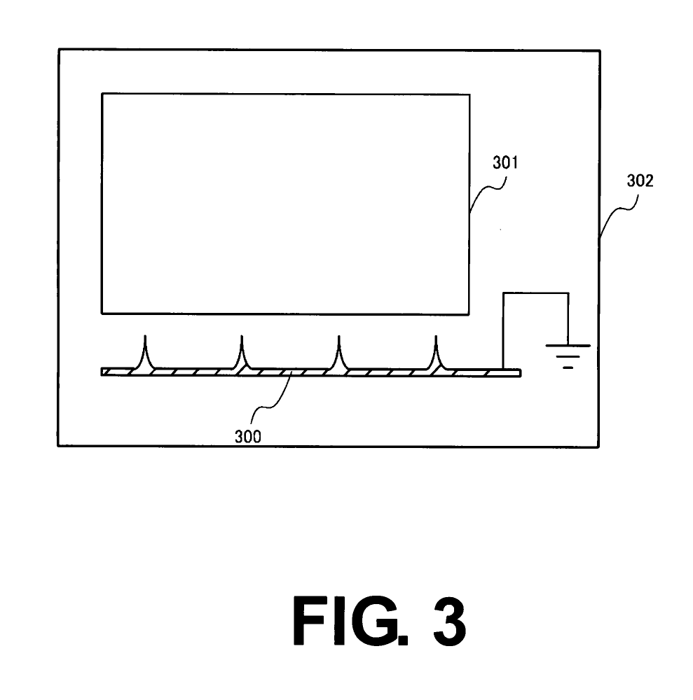

With reference to FIG. 3, the overall configuration of the static electricity protection pattern formed on the circuit board pertaining to the present invention will be described next.

FIG. 3 is a diagram showing a circuit board 302 on which the overall shape of the static electricity protection pattern does not surround the protection target.

As shown in FIG. 3, a static electricity protection pattern 300 formed on the circuit board 302 pertaining to the present invention does not have the shape in which the protection pattern surrounds the protection target as described in FIGS. 1 and 2, but have a shape in which the protection pattern exists linearly in a part of the periphery of a circuit 301.

Additionally, the static electricity protection pattern 300 has a sharp angled projection, and is connected to the ground.

As described above, the static electricity protection pattern 300 formed on the circuit board 302 pertaining to the present invention can be formed to not have a shape in which the protection target is fully surrounded, but have a shape in which the protection pattern exists in a part of the periphery of the protection target. Additionally, the protection pattern can have a different shape from the linear shape as shown in FIG. 3, and may have various shapes.

Although a detailed description will be made later, the static electricity protection pattern 300 may protects not only the circuit 301, but also various electronic components or signal lines installed on the circuit board 302. In this case, the static electricity protection pattern is formed in a part of the periphery of the various electronic components or signal lines to be protected.

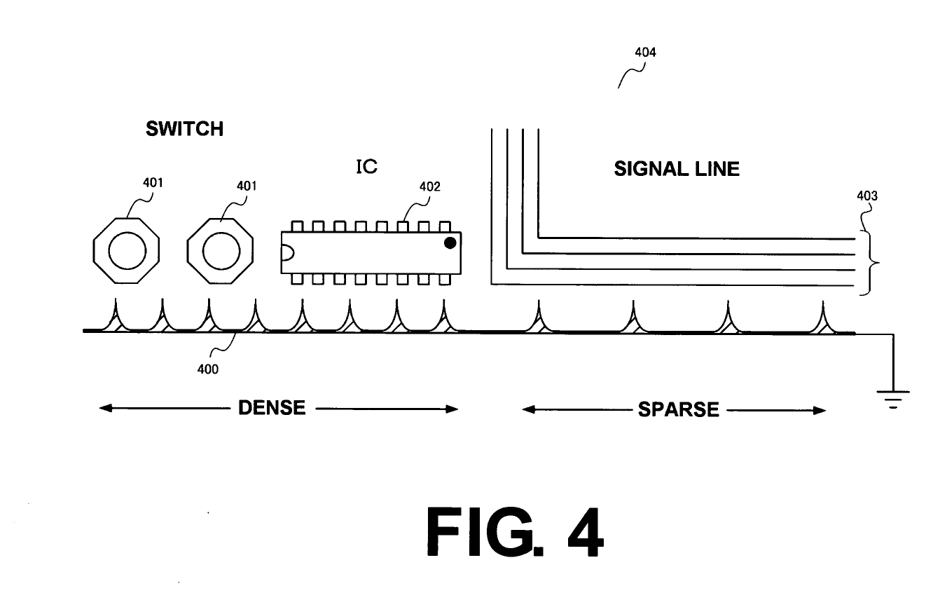

With reference to FIG. 4, an interval between the projection and the adjacent projection will be described next in connections with plural projections of the static electricity protection pattern formed on the circuit board pertaining to the present invention.

FIG. 4 is a diagram showing that a part of a circuit board 404 in which the interval between each of the projections of the static electricity protection pattern includes both dense part and sparse part is enlarged.

As shown in FIG. 4, the interval between each of the projections of a static electricity protection pattern 400 formed on the circuit board 404 pertaining to the present invention may be formed to include a dense or sparse part comparing with other intervals between the projections.

For example, in the vicinity of electronic components that are likely to have the static electricity, such as a switch 401 or IC 402, the interval between the projections of the static electricity protection pattern 400 may be set to be dense. On the other hand, in the vicinity of a signal line 403 that is less likely to have the static electricity, the interval between the projections of the static electricity protection pattern 400 may be set to be sparse.

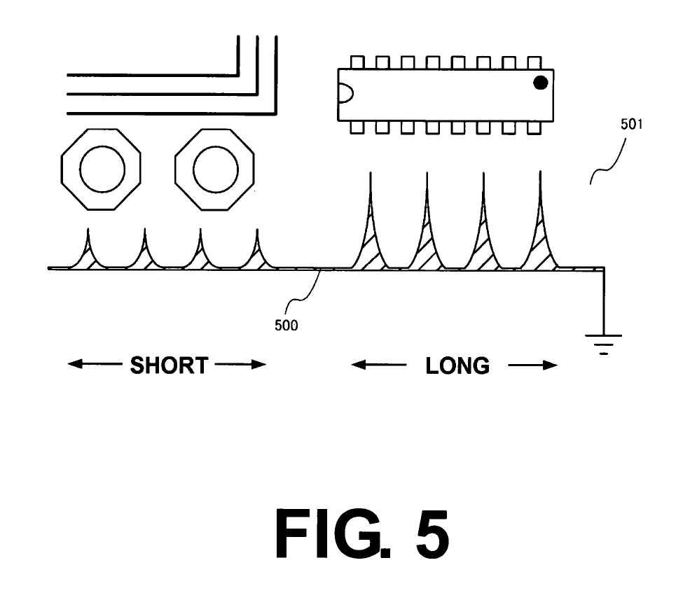

With reference to FIG. 5, length of the projection of the static electricity protection pattern formed on the circuit board pertaining to the present invention will be described next.

FIG. 5 is a diagram showing that a part of a circuit board 501 having the static electricity protection pattern having a long projection and a short projection is enlarged.

As shown in FIG. 5, a static electricity protection pattern 500 formed on the circuit board 501 pertaining to the present invention may have both a shorter length of projection as compared with other projections and a longer length of projection as compared with other projections.

Each of the projection lengths of the static electricity protection pattern 500 can be changed depending on arrangement of signal lines, electronic components, and so on, or on the value of resistance of the static electricity protection pattern.

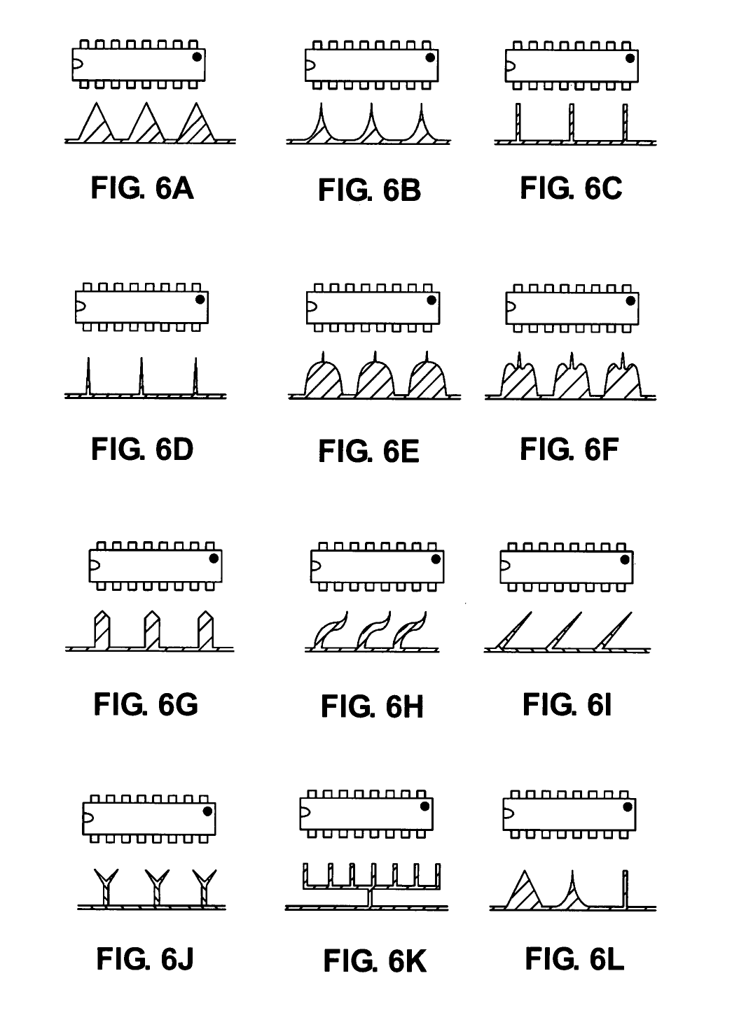

With reference to FIGS. 6A through 6L, shapes of the projections of the static electricity protection pattern formed on the circuit board pertaining to the present invention will be described next.

FIGS. 6A through 6L are diagrams showing various shapes of the projections of the static electricity protection pattern formed on the circuit board pertaining to the present invention.

The projection of the static electricity protection pattern formed on the circuit board pertaining to the present invention can be formed in various shapes, provided that the static electricity is guided to the projection.

For example, the projection can be formed in a shaped as shown in FIGS. 6A through 6K.

FIG. 6A provides an example of a projection having a sharp angled top end and a triangle shape.

Additionally, FIG. 6B provides an example of a projection having a mountain and triangle shape in which the top end of the projection is a sharp angle, and the base part thereof is a gentle slope.

Additionally, FIG. 6C provides an example of a projection having a bar shape.

Additionally, FIG. 6D provides an example of a projection having a needle shape with a sharp angled top end.

Additionally, FIG. 6E provides an example of a projection having a bell shape with a sharp angled top end.

Additionally, FIG. 6F provides an example of a projection having a shape in which a top end is a sharp angle and an adjacent area of the top end of the projection bulges like a sectional view of an apple.

Additionally, FIG. 6G provides an example of a projection having a shape in which a top end is a sharp-angled and triangle shape, and the main body of the projection is a bar shape.

Additionally, FIG. 6H provides an example of a projection having a sharp-angled top end and a wave-like shape.

Additionally, FIG. 6I provides an example of a projection having a shape in which the projection is not perpendicular but tilted with respect to a signal line connecting the projections.

Additionally, FIGS. 6J and 6K provide examples of a projection having plural projections on a top end.

FIG. 6J provides an example of the projection having a Y shape in which the top end of the projection has plural sharp angled projections. FIG. 6K provides an example of the projection having an antenna-like shape with plural projections on the top end.

As described above, the projection of the static electricity protection pattern formed on the circuit board pertaining to the present invention can be formed in various shapes.

Additionally, FIG. 6L provides an example of the static electricity protection pattern in which various shapes of projection are incorporated in one static electricity protection pattern.

As described above, the projection of the static electricity protection pattern can be formed to be incorporated in one static electricity protection pattern.

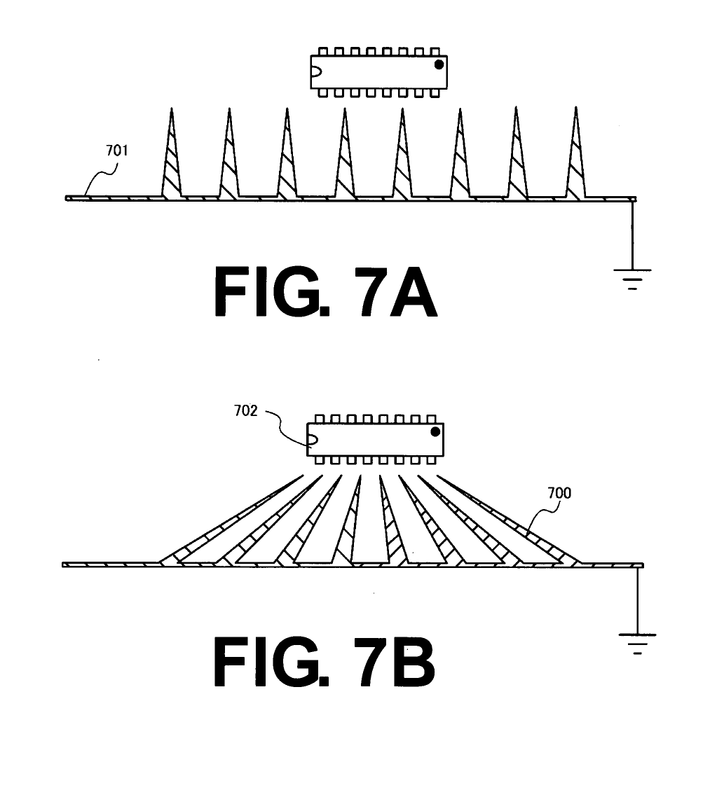

Next, with reference to FIGS. 7A and 7B, a description will be made of the static electricity protection pattern in a case where each of the plural projections of the static electricity protection pattern formed on the circuit board pertaining to the present invention has different directions.

FIGS. 7A and 7B are diagrams showing a static electricity protection pattern 700 in the case where each of the plural projections has different directions.

In an ordinary case, as shown in FIG. 7A, the direction of the projection is perpendicular to a signal line 701 connecting the projections.

However, the direction of the projections of the static electricity protection pattern 700 formed on the circuit board pertaining to the present invention is not necessarily in the same direction.

Additionally, as shown in FIG. 7B, the direction of the projections of the static electricity protection pattern 700 may be formed in a direction focused on the protection target (In this case, IC 702).

By focusing the top ends of the projections on the IC 702 as shown in FIG. 7B, the larger number of the top ends of projections are located in the vicinity of the IC 702, as compared with the ordinary case shown in FIG. 7A.

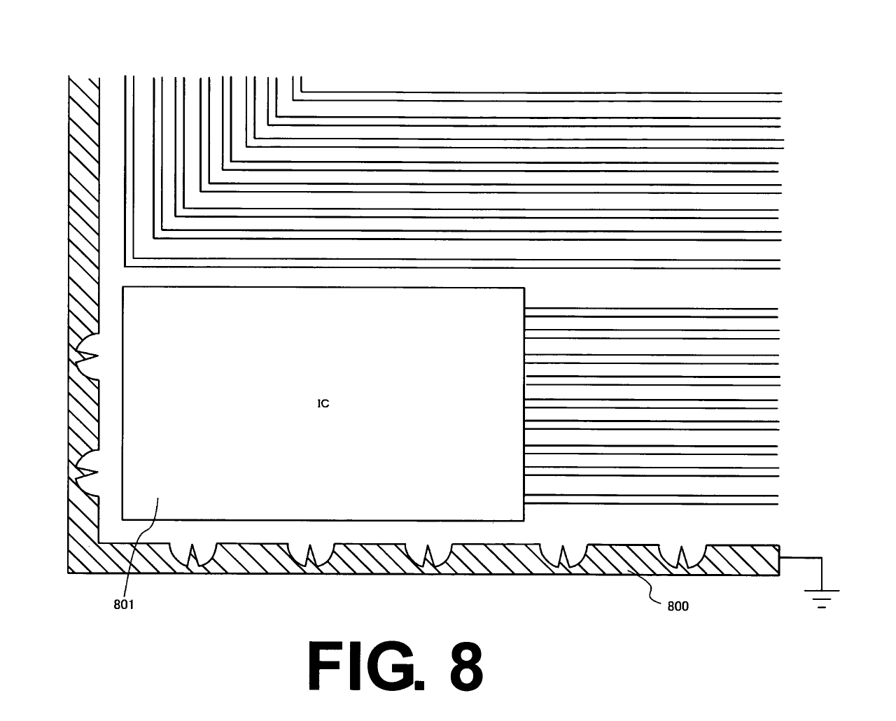

Next, with reference to FIG. 8, a description will be made of an example shape of the static electricity protection pattern in a case where the static electricity protection pattern formed on the circuit board pertaining to the present invention is formed on a circumference part of the board.

FIG. 8 is a diagram showing a static electricity protection pattern 800, which is an example of the static electricity protection pattern formed on the circumference part of the circuit board.

In the densely packed circuit board, an IC 801 to be protected may be installed on the circumference part. In this case, by carving a part of the ground on the circumference part as shown in FIG. 8, the static electricity protection pattern 800 can be formed with a shape having a projection in the carved part.

With the static electricity protection pattern 800 as described above, the densely packed circuit board on which the IC or signal line is arranged around the edge of the circuit can also be protected from the static electricity.

Although the static electricity protection pattern 800 shown in FIG. 8 has a projection facing toward the IC 801, the protection pattern 800 may also have a projection facing in a direction opposite to the IC 801.

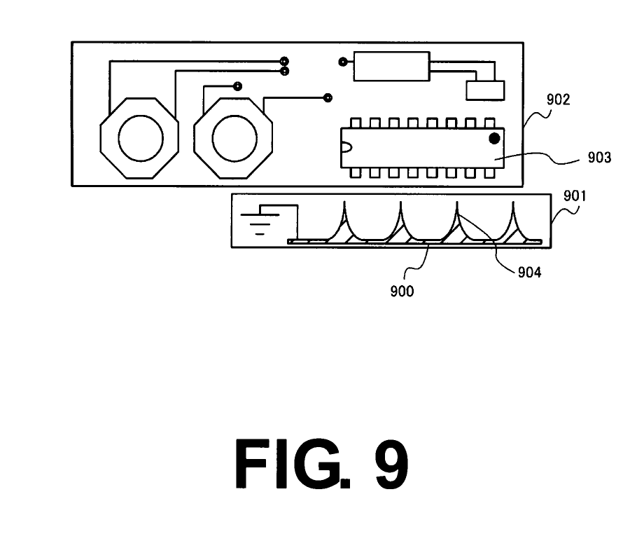

Next, with reference to FIG. 9, a description will be made of a case where the protection target of the static electricity protection pattern formed on the circuit board pertaining to the present invention does not exist in its own circuit board, but exists in another adjacent circuit board.

FIG. 9 shows a circuit board A 901 on which a static electricity protection pattern 900 is formed, and a circuit board B 902 having a protection target protected by the static electricity protection pattern 900.

As shown in FIG. 9, in the circuit board A 901, the static electricity protection pattern 900 having the static electricity protection pattern formed on the circuit board pertaining to the present invention as described with reference to FIGS. 1 through 8 is formed.

Additionally, the circuit board A 901 and the circuit board B 902 are adjacent to each other.

The static electricity protection pattern 900 on the circuit board A 901 guides to its own projection 904 the static electricity that is likely to be transferred from outside of the circuit board B 902 to an IC 903 on the circuit board B 902, and leads it to the ground. Additionally, the static electricity that occurs on the circuit board B 902 and that is accumulated to the IC 903 is also guided to the projection 904 and led to the ground.

As described above, the static electricity protection pattern formed on the circuit board can protect the adjacent circuit board from the static electricity.

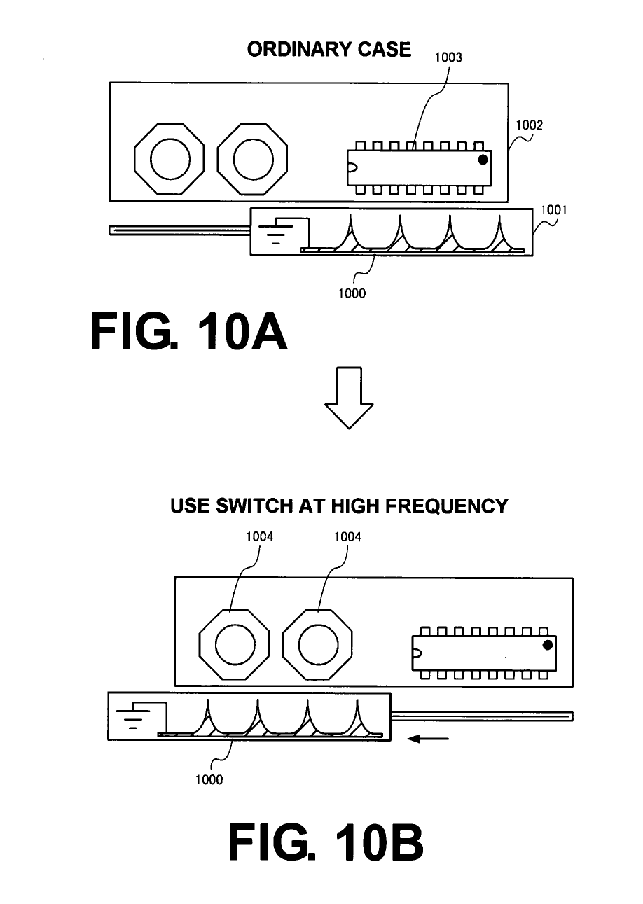

Next, with reference to FIGS. 10A and 10B, a description will be made of an example where the circuit board having the static electricity protection pattern pertaining to the present invention can be moved.

FIGS. 10A and 10B are diagrams showing a state where a circuit board C 1001 having a static electricity protection pattern protecting an adjacent circuit board D 1002 is moved.

The circuit board C 1001 can linearly move in the vicinity of the circuit board D 1002 using a connected movement mechanism not shown in the figure.

As shown in FIG. 10A, in an ordinary case, the circuit board C 1001 is located in a place where the static electricity protection pattern is located near an IC 1003 on the adjacent circuit board D 1002.

When a switch 1004 on the circuit board D 1002 is expected to be used frequently, the circuit board C 1001 is automatically moved in order to protect the switch 1004 from the static electricity. Then, as shown in FIG. 10B, the static electricity protection pattern 1000 becomes located near the switch 1004.

As described above, the circuit board C 1002 having the static electricity protection pattern 1000 is moved as necessary, whereby the target to be protected from the static electricity by the static electricity protection pattern 1000 can be changed in accordance with the case.

Hereinbelow, the static electricity protection patter formed on the circuit board pertaining to the present invention will be described with specific examples of the protection target.

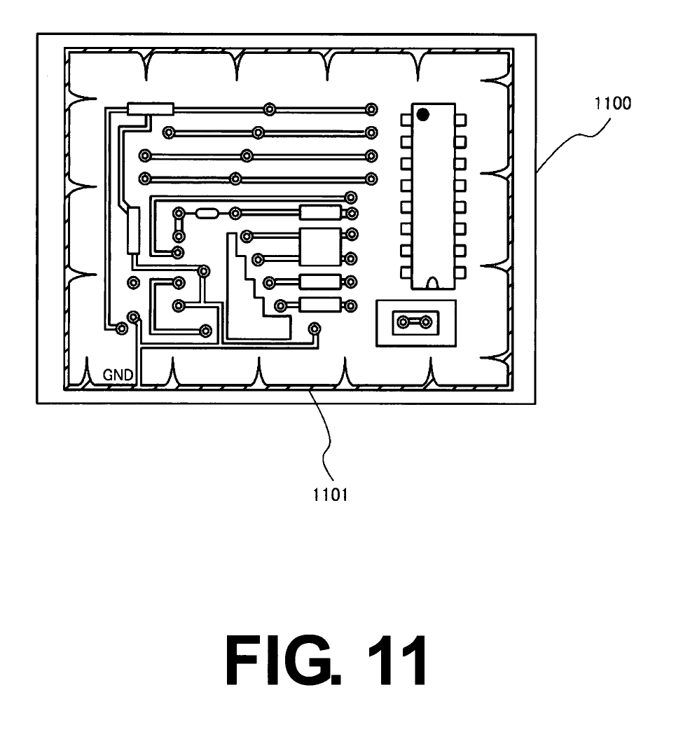

Firstly, with reference to FIG. 11, a description will be made of an example case where the static electricity protection pattern formed on the circuit board pertaining to the present invention protects the whole circuit.

FIG. 11 is a diagram showing a circuit board 1100 pertaining to the present invention.

A static electricity protection pattern 1101 is formed in the circuit board 1100 as a conductor pattern.

As shown in FIG. 11, the static electricity protection pattern 1101 is formed to surround the whole circuit. Additionally, plural projections of the static electricity protection pattern 1101 face toward the circuit located in the surrounded area, and the protection pattern 1101 is connected to the ground.

The static electricity transferred from the outside of this circuit board 1100 to inside the circuit is guided to the projection of the static electricity protection pattern 1101, and is led to the ground.

Additionally, the static electricity accumulated through operation of the circuit on the circuit board 1100 is also guided to the static electricity protection pattern 1101, and led to the ground.

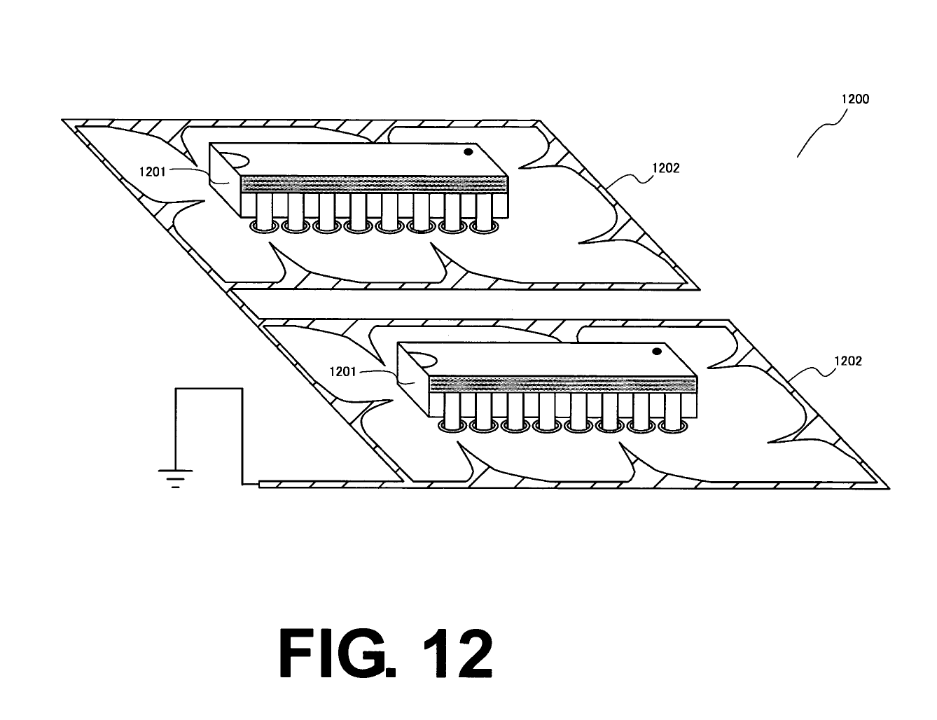

Next, with reference to FIG. 12, a description will be made of an example where the static electricity protection pattern formed on the circuit board pertaining to the present invention protects the IC.

FIG. 12 is a diagram in which a part of the circuit board 1200 having a static electricity protection pattern 1202 protecting an arranged IC 1201 pertaining to the present invention is enlarged.

On the circuit board 1200, the static electricity protection pattern 1202 is formed in advance, as a conductor pattern, around a location where the IC 1201 is soldered.

Then, as shown in FIG. 12, when the IC 1201 is soldered on the circuit board 1200, the static electricity protection pattern 1202 in which the top end of projection thereof faces toward the IC 1201 is formed to surround the periphery of the arranged IC 1201.

The protection target of the static electricity protection pattern 1202 as formed above may not only be the IC 1201, but also be an electronic part arranged on the circuit board 1200. And, the protection pattern 1202 is formed, in advance, around a location where the electronic part is arranged.

With this static electricity protection pattern 1202, even when the circuit board 1200 is installed in a more likely place where the static electricity occurs outside the circuit board 1200, the static electricity that is likely to be transferred from the outside of the circuit board 1200 to the IC 1201 is guided to the static electricity protection pattern 1202, and is led to the ground.

Additionally, the static electricity accumulated in the IC 1201 through operation of the circuit is also guided to the static electricity protection pattern 1202, and is led to the ground.

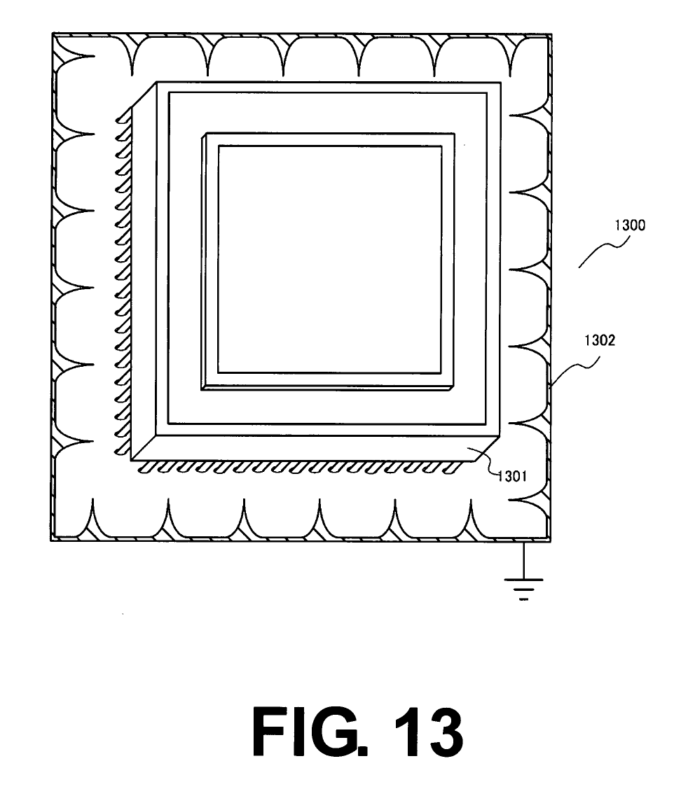

Next, with reference to FIG. 13, a description will be made of an example where the static electricity protection pattern formed on the circuit board pertaining to the present invention protects the CCD susceptible to the static electricity.

FIG. 13 is a diagram in which a part of a circuit board 1300 having a static electricity protection pattern 1302 protecting an arranged CCD 1301 pertaining to the present invention is enlarged.

In this description, it is assumed that this CCD 1301 is a CCD for converting an image taken through a lens of a digital camera into a digital image, or a CCD installed in a fingerprint authentication device and detecting a fingerprint pattern. However, this CCD 1301 may also be a CCD used for various other applications.

Additionally, in place of the CCD 1301, an electronic component that is easily malfunctioned or damaged as a result of static electricity may be installed in the circuit board 1300.

The static electricity protection pattern 1302 on the circuit board 1300 is formed in advance, as a conductor pattern, in the periphery of a place where the CCD 1301 is placed.

Additionally, when the CCD 1301 is placed on the circuit board 1300, as shown in FIG. 13, the static electricity protection pattern 1302 in which the top end of the projection faces toward the CCD 1301 is formed so as to exist around the placed CCD 1301.

With this static electricity protection pattern 1302, even when the circuit board 1300 is installed in a more likely place where the static electricity occurs outside the circuit board 1300, the static electricity that is likely to be transferred from the outside of the circuit board 1300 to the CCD 1301 is guided to the static electricity protection pattern 1302, and is led to the ground, whereby the CCD 1301 is protected from the static electricity.

Additionally, the static electricity accumulated in the CCD 1301 through operation of the circuit is guided to the static electricity protection pattern 1302, and is led to the ground, whereby the CCD 1301 is protected from the static electricity.

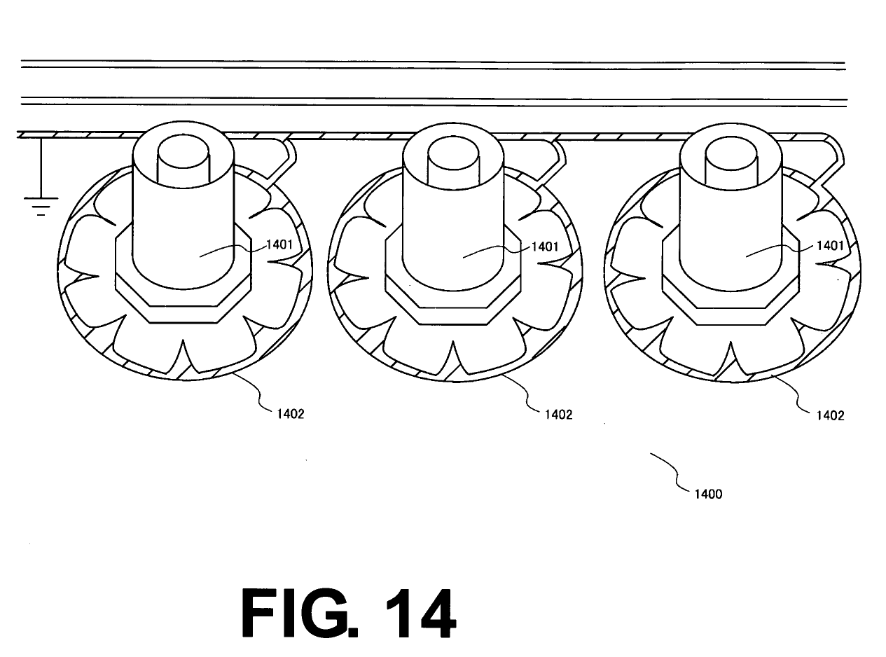

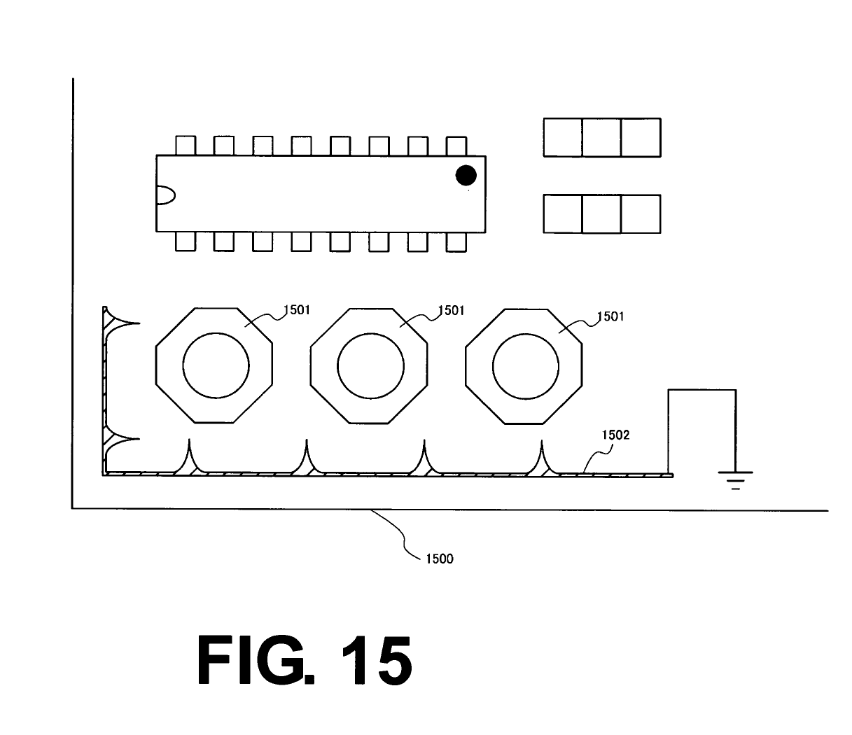

Next, with reference to FIGS. 14 and 15, a description will be made of an example where the static electricity protection pattern formed on the circuit board pertaining to the present invention protects a switch.

FIG. 14 is a diagram in which a part of the circuit board 1400 having a static electricity protection pattern 1402 protecting an installed switch 1401 pertaining to the present invention is enlarged.

On the circuit board 1400, the static electricity protection pattern 1402 is formed in advance, as a conductor pattern, around a place where the switch 1401 is soldered.

Additionally, when the switch 1401 is soldered on the circuit board 1400, as shown in FIG. 14, the static electricity protection pattern 1402 in which the top end of the projection faces toward the switch is formed so as to surround the periphery of the installed switch 1401.

With this static electricity protection pattern 1402, even when the circuit board 1400 is installed in a more likely place where the static electricity to occurs outside the circuit board 1400, the static electricity that is likely to be transferred from the outside of the circuit board 1400 to the switch 1401 is guided to the static electricity protection pattern 1402, and is led to the ground, whereby the switch 1401 is protected from the static electricity.

Additionally, the static electricity accumulated in the switch 1401 via the signal line through operation of the circuit, or the static electricity accumulated in the switch 1401 through operation of the switch 1401 itself is guided to the static electricity protection pattern 1402, and is led to the ground, whereby the switch 1401 is protected from the static electricity.

FIG. 15 is a diagram in which a part of a circuit board 1500 having a static electricity protection pattern 1502 protecting an installed switch 1501 pertaining to the present invention is enlarged.

On the circuit board 1500, the static electricity protection pattern 1502 is formed in advance, as a conductor, around a place where the switch 1501 is soldered.

Additionally, when the switch 1501 is soldered, as shown in FIG. 15, the L-shaped static electricity protection pattern 1502 in which the top end of the projection faces toward the switch 1501 is formed so as to exist around the installed switch 1501.

As described with reference to FIG. 3, this static electricity protection pattern 1502 is not formed to surround the switch 1501 to be protected, but exists in an L-shaped form in a part of the vicinity of the switch 1501 to be protected.

The shape of the static electricity protection pattern 1502 is not limited to the L-shape, but may be in a linear shape or wave-like shape. Furthermore, the protection pattern 1502 may be formed in various other shapes.

With this static electricity protection pattern 1502, even if the circuit 1500 is placed to a more likely place where the static electricity occurs outside, the static electricity that is likely to be transferred from the outside of the circuit board 1500 to the switch 1501 is guided to the static electricity protection pattern 1502, and is led to the ground, whereby the switch 1501 is protected from the static electricity.

Additionally, the static electricity accumulated to the switch 1501 via the signal line through operation of the circuit, or the static electricity accumulated through operation of the switch 1501 itself is guided to the static electricity protection pattern 1502, and is led to the ground, whereby the switch 1501 is protected from the static electricity.

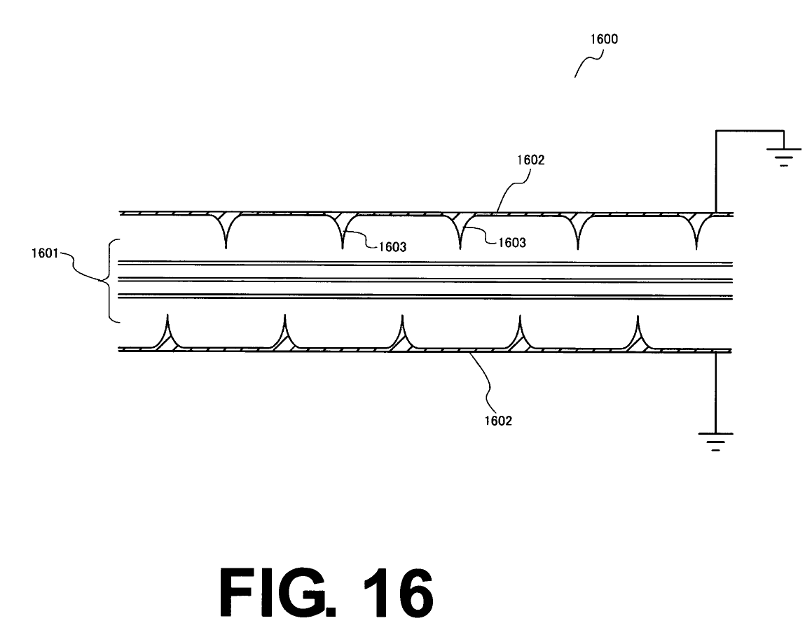

Next, with reference to FIG. 16, a description will be made of an example where the static electricity protection pattern formed on the circuit board pertaining to the present invention protects a signal line.

FIG. 16 is a diagram in which a part of a circuit board 1600 having a static electricity protection pattern 1602 protecting a placed signal line 1601 is enlarged.

On the circuit board 1600, similar to the signal line 1601, the static electricity protection pattern 1602 is formed as a conductor pattern in advance.

As shown in FIG. 16, the static electricity protection pattern 1602 is formed such that the top end of a projection 1603 faces toward the signal line 1601 to be protected and is located in the vicinity of the signal line 1601.

In FIG. 16, the signal line connecting each of the projections 1603 in the static electricity protection pattern 1602 runs parallel to the signal line 1601 to be protected. However, this signal line connecting each of the projections 1603 does not necessarily run parallel to the signal line 1601 to be protected.

Additionally, FIG. 16 shows that the static electricity protection pattern 1602 is formed so as to sandwich the signal line 1601 and be located on both side of the signal line 1601. However, the static electricity protection pattern 1602 is not necessarily formed on both side of the signal line 1601, and may be formed on either one of the sides.

With this static electricity protection pattern 1602, even if the circuit board 1600 is placed to a more likely place where the static electricity occurs outside the circuit board 1600, the static electricity that is likely to be transferred from the outside of the circuit board 1600 to the signal line 1601 is guided to the static electricity protection pattern 1602, and is led to the ground.

Additionally, the static electricity caused through operation of the circuit is also guided to the static electricity protection pattern 1602, and is led to the ground.

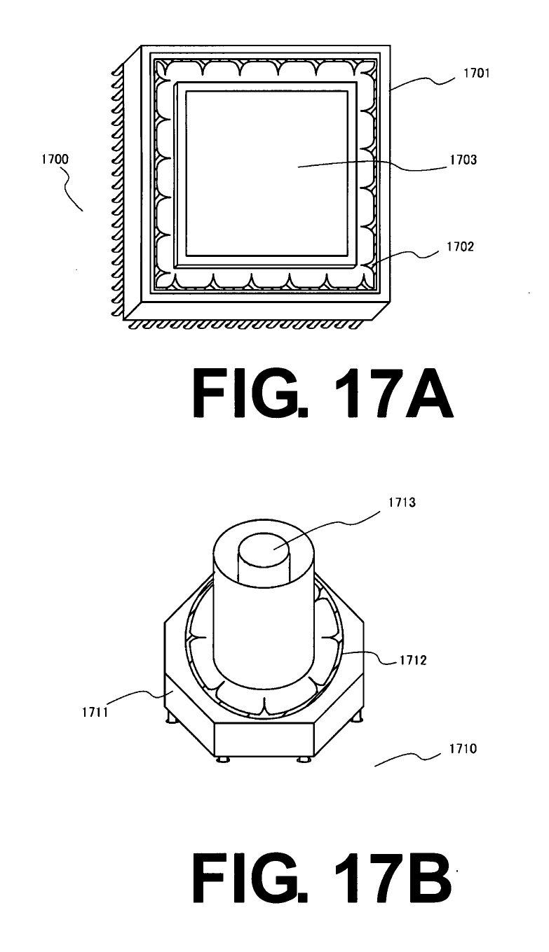

With reference to FIGS. 17A and 17B, an electronic component pertaining to the present invention is described next.

On the electronic component described below, the static electricity protection pattern formed on the circuit board described above is formed.

FIGS. 17A and 17B are diagrams showing examples of electronic components pertaining the present invention. FIG. 17A is a diagram showing a CCD 1701 in which the static electricity protection pattern is formed, and FIG. 17B is a diagram showing a switch 1711 in which the static electricity protection pattern is formed.

As shown in FIG. 17A, the CCD 1701 is an electronic component placed on a circuit board 1700

Additionally, the CCD 1701 has an image pickup section 1703 in which elements for converting from light to electric signal are arranged to pickup an image, and also has a static electricity protection pattern 1702 protecting the image pickup section 1703.

The static electricity protection pattern 1702 is formed around the image pickup section 1703, is a conductor having plural projections, and is connected to the ground in the CCD 1701.

Each of the top ends of the plural projections in the static electricity protection pattern 1702 faces toward the image pickup section 1703.

Therefore, the static electricity accumulated in the image pickup section 1703 is guided to the projections of the static electricity protection pattern 1702, and is led to the ground.

The CCD 1701 is created by attaching, on the CCD 1701, the copper foil formed in a shape of the static electricity protection pattern 1702 in advance, and connecting the copper foil to the ground in the CCD 1701.

As described above, the static electricity protection pattern 1702 is located on the CCD 1701, which is an electronic component, whereby the static electricity accumulated in the image pickup section 1703 on the CCD 1701 can be guided to the projections of the static electricity protection pattern 1702, and be led to the ground.

Additionally, as shown in FIG. 17B, the switch 1711 is an electronic component installed on the circuit board 1710.

Additionally, the switch 1711 has a pushing section 1713 that is depressed through operation of a human, and a static electricity protection pattern 1712 protecting the pushing section 1713.

The static electricity protection pattern 1712 is formed around the pushing section 1713, is a conductor having plural projections, and is connected to the ground in the switch 1711.

Each of the top ends of the plural projections of the static electricity protection pattern 1712 faces toward the pushing section 1713.

Therefore, the static electricity transferred from the fingertip of the human to the pushing section 1713 is guided to the projection of the static electricity protection pattern 1712, and is led to the ground.

The switch 1711 is created by attaching, on the switch 1711, the copper foil formed in a shape of the static electricity protection pattern 1712 in advance, and connecting the copper foil to the ground in the switch 1711.

As described above, the static electricity protection pattern is located on the switch 1711, which is an electronic component, whereby the static electricity accumulated in the pushing section 1713 on the switch 1711 can be guided to the projection of the static electricity protection pattern 1712, and be led to the ground.

It should be noted that the specific shape of the static electricity protection pattern described with reference to FIGS. 11 through 17B is not limited to the shapes indicated in FIGS. 11 through 17B. The static electricity protection pattern can also be formed in various shapes that have the feature of the static electricity protection pattern of the circuit board pertaining to the present invention as described with reference to FIGS. 1 through 10B.

In other words, the shape of the static electricity protection pattern formed on the electronic component pertaining to the present invention is also not limited to the shapes as described with reference to FIGS. 17A and 17B. The static electricity protection pattern can also be formed in various shapes that have the feature of the static electricity protection pattern of the circuit board pertaining to the present invention as described with reference to FIG. 1 through 10B.

It should understood that, in the electronic component in which the static electricity protection pattern having the feature of the static electricity protection pattern as described with reference to FIG. 9 is formed, the target protected by the static electricity protection pattern is not located in the electronic component itself, but the target is other adjacent electronic component, signal line, and so on.

It should be noted that the sharp angled projection of the static electricity protection pattern formed on the circuit board pertaining to the present invention is not limited to facing toward the protection target as described with reference to FIGS. 1 and 3, and but the circuit board may be a circuit board on which the static electricity protection pattern having the sharp angled projection directing only in the opposite direction to the protection target is formed.

The static electricity protection pattern having the projection directing only in the opposite direction to the protection target can be applicable to the static electricity protection pattern as described with reference to FIGS. 4 through 17B.

The present invention can be utilized for a circuit board and electronic component.

According to an aspect of the present invention, the circuit on the circuit board can be protected from the static electricity by guiding the static electricity that is likely to be transferred from the outside of the circuit board to the circuit inside to the static electricity protection pattern on the circuit board, and leading it to the ground.

Additionally, according to an aspect of the present invention, the circuit on the circuit board can be protected from the static electricity by guiding the static electricity accumulated in the circuit through its own operation on the circuit board to the static electricity protection pattern, and leading it to the ground.

Additionally, according to an aspect of the present invention, the electronic component can be protected from accumulating the static electricity by guiding the static electricity that is likely to be accumulated in the electronic component to the static electricity protection pattern on the electronic component, and leading it to the ground.

The foregoing description of the exemplary embodiment of the present invention is provided for the purposes of illustration and description. It is not intended to be exhaustive or to limit the invention to the precise forms disclosed. Obviously, many modifications and variations will be apparent to practitioners skilled in the art. The exemplary embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A circuit board, comprising
a static electricity protection conductor formed around a protection target to be protected from static electricity, the static electricity protection conductor having one or more projections and being grounded at one or more points.

2. The circuit board according to claim 1, wherein the one or more projections comprise one or more first projections in which a top end faces toward the protection target.

3. The circuit board according to claim 1, wherein
the one or more projections comprise one or more first projections in which a top end faces toward the protection target, and one or more second projections in which a top end faces toward a direction different from the protection target.

4. The circuit board according to claim 1, wherein the static electricity protection conductor has a shape surrounding the protection target.

5. The circuit board according to claim 2, wherein the static electricity protection conductor has a shape surrounding the protection target.

6. The circuit board according to claim 1, wherein an interval between adjacent projections is 10 mm or less.

7. The circuit board according to claim 2, wherein an interval between adjacent projections is 10 mm or less.

8. The circuit board according to claim 3, wherein an interval between adjacent projections is 10 mm or less.

9. The circuit board according to claim 4, wherein an interval between adjacent projections is 10 mm or less.

10. The circuit board according to claim 5, wherein an interval between adjacent projections is 10 mm or less.

11. The circuit board according to claim 1, wherein the protection target comprises at least:
a circuit placed on a board,
an electronic component placed in the circuit, and
a signal line printed on the board.

12. The circuit board according to claim 2, wherein the protection target comprises at least:
a circuit placed on a board,
an electronic component placed in the circuit, and
a signal line printed on the board.

13. The circuit board according to claim 3, wherein the protection target comprises at least:
a circuit placed on a board,
an electronic component placed in the circuit, and
a signal line printed on the board.

14. The circuit board according to claim 4, wherein the protection target comprises at least:
a circuit placed on a board,
an electronic component placed in the circuit, and
a signal line printed on the board.

15. The circuit board according to claim 5, wherein the protection target comprises at least:
a circuit placed on a board,
an electronic component placed in the circuit, and
a signal line printed on the board.

16. The circuit board according to claim 6, wherein the protection target comprises at least:
a circuit placed on a board,
an electronic component placed in the circuit, and
a signal line printed on the board.

17. The circuit board according to claim 7, wherein the protection target comprises at least:
a circuit placed on a board,
an electronic component placed in the circuit, and
a signal line printed on the board.

18. The circuit board according to claim 8, wherein the protection target comprises at least:
a circuit placed on a board,
an electronic component placed in the circuit, and
a signal line printed on the board.

19. The circuit board according to claim 9, wherein the protection target comprises at least:
a circuit placed on a board,
an electronic component placed in the circuit, and
a signal line printed on the board.

20. The circuit board according to claim 10, wherein the protection target comprises at least:
a circuit placed on a board,
an electronic component placed in the circuit, and
a signal line printed on the board.

21. An electronic component, comprising
a static electricity protection conductor formed around a protection target to be protected from static electricity, the static electricity protection conductor having one or more projections and being grounded at one or more points.
